(19) United States
(12) Patent Application Publication
(10) Pub. No.: US 2018/0115543 A1
(43) Pub. Date: Apr. 26, 2018

(54) METHODS AND SYSTEMS FOR PROVIDING A ONLINE COMMUNICATION PLATFORM FOR A TARGETED COMMUNITY OF PEOPLE

(71) Applicant: STEVANATO GROUP S.P.A., Padova (IT)

(72) Inventor: Christophe BUREAU, Grenoble (FR)

(73) Assignee: STEVANATO GROUP S.P.A., Padova (IT)

(21) Appl. No.: 15/567,290

(22) PCT Filed: Mar. 8, 2016
(86) PCT No.: PCT/EP2016/054866

§ 371 Date: Oct. 17, 2017

Related U.S. Application Data
(60) Provisional application No. 62/148,794, filed on Apr. 17, 2015.

(51) Int. Cl. H04L 29/06; G06F 21/62; G06Q 50/00; G06K 19/06; G06K 19/07

(52) U.S. Cl. CPC H04L 63/0807; H04L 63/102; G06K 19/0723; G06Q 50/01; G06K 19/06037; G06F 21/6245

(57) ABSTRACT

The method for providing an online communication platform for a targeted community of people, by choosing a community of people, and identifying a product accessed by said community of people, said product comprising one or more product units. Providing a product identifier on said product units and providing an online communication platform. The online communication platform is accessed by reading the product identifier using a suitable device or entering the product identifier manually into a suitable piece of software; and the product identifier is the only way for a user to access the online communication platform.

### CROSS-REFERENCE TO RELATED APPLICATIONS

This is a U.S. national phase application under 35 U.S.C. § 371 of International Patent Application No. PCT/EP2016/054866, filed Mar. 8, 2016, and claims benefit of priority to U.S. Provisional Application No. 62/148,794, filed Apr. 17, 2015. The entire contents of these applications are hereby incorporated by reference.

### FIELD OF THE INVENTION

The present invention relates to methods and systems for providing an online communication platform for a targeted community of people.

In particular the present invention relates to methods and systems for selectively providing a secure online communication platform for a community of people linked through the contact with specific products. The methods and systems of the invention thereby provide an online platform for users of a given product to interact in a secure environment without the need to specifically identifying an individual user.

### BACKGROUND

Today social media has very much become part of the fabric of our communication and to a certain degree even of society. Online platforms like Facebook or Second Life as well as a large number of online forums and message boards give people the chance to exchange information about a great variety of subjects.

In particular with respect to self-help groups and online communities linked to medical conditions though there is the issue that it is often not possible to ascertain if a member of such a forum does indeed suffer from or care for a person suffering the condition that is the subject of the forum. Therefore some people might still feel inhibited to openly discuss their problems out of fear of “outing” their condition to the wider world. Furthermore a lack or screening can also lead to issues of trolling, which can be particularly problematic if a forum is dedicated to the discussion of mental health issues or conditions that are perceived as being lifestyle related such as diabetes or obesity. Finally in the absence of any screening of the members of an online community it is very difficult to ascertain if any experiences described and tips given are from a genuine sufferer or caregiver or just made up. Consequently such information will always be taken with a significant degree of suspicion.

In contrast thereto the screening of members in real world self-help groups is much easier as they are by nature built around face-to-face contact. While it might be possible to verify if a person is indeed suffering from or caring for a person suffering the condition that is the subject of the forum, these methods will most likely involve the provision of a proof such as a doctors certificate and will lead to the identification of an individual. This again might scare people off as they would be forced to reveal their condition to at least the administrators of the forum. Furthermore such an identification process might in some countries be problematic in view of the various data protection laws and regulations.

Yet in particular with respect to chronic or long-term illnesses where regular medication is necessary it has been shown that support from other patients and the possibility to discuss specific issues with other patients which are more likely perceived as peers rather than medical professionals significantly increases patient compliance. This in particular if the medication is unpleasant or perceived to be difficult to administer as is for example the case for the injection of insulin or connected to significant side-effects as is for example the case for antiretroviral treatment regimes for HIV/AIDS patients.

Furthermore chronic and long-term illnesses are often associated with co-morbidities as well mental health problems such as depression which would benefit from help and support from the wider community of patients.

It would therefore be useful to be able to provide an online communication platform that provides specific and secure access to defined communities without having to individually identify the user.

The present inventors have now observed that various communities are often linked by specific products, be it moisturizing cream for people with dry skin, infant formula for parents of babies or insulin cartridges for diabetes patients or their caregivers. These products therefore form a way of identifying a person as belonging to a certain group. This identification is particularly strong and reliable if the linking product is a prescription drug. One linking factor thereby is that the members of a community will be exposed to the packaging of the products they use, consume or otherwise come into contact with.

Such an identification can then be used as an entry ticket into an online community to ensure that only people coming into contact with this particular product have access to a given online community.

In the context of the present invention reference is made to a “product”. This term is used to refer to an item or a combination of several items that is commonly used or accessed by a selected community of people in relation for example to:
their health condition (e.g. an insulin cartridge or an insulin vial or a pen, for patients having diabetes and taking insulin, a prefilled syringe or an auto-injector for patients having multiple sclerosis or rheumatoid arthritis, an epinephrine autoinjector (EpiPen, AuviO) for people suffering from severe allergic reactions or antiretroviral medication for HIV/AIDS sufferers)
their habits or lifestyle (e.g. sports shoes or dietary supplements for people practicing fitness; or infant formula for parents having babies or small children)
their professional occupation (e.g. stent boxes for nurses assisting cardiologists and cardiologists themselves, pens or insulin cartridges for nurses assisting diabetic patients, prefilled syringes for nurses or doctors performing immunisations)

This list is merely meant as an example and is by no means exhaustive but demonstrates that a given product can be used to identify members of communities of people coming into contact with said product, regardless of other characteristics (e.g. location, demographic, professional position) of people in that community. The term product may thereby refer to a generic item or a specific item such as for example a product made by a specific manufacturer or a product sold under a specific brand or product name.

While in the context of the invention specific reference might be made to medical products it is clear that the methods and systems of then invention are not restricted to medical products but can be used in connection with any product that provides a link to a given community.

While there have been attempts to use the packaging for communicating with an audience, in particular with respect to advertisements, customer loyalty schemes and competitions the uses so far require the user to log onto a specific web-site or web-service and create a specific profile for himself

One such system is for example described in US 2014/0019606.

These systems though have several drawbacks. First of all they rely on the user to create a profile with the respective web-site or web-service, something that in an age of increased concern about the protection of personal data has become increasingly difficult. This especially if the system furthermore relies on the entry of a correct set of data as often users input incorrect data be it out of negligence or in order not divulge data they consider personal and sensitive.

This problem exacerbated if the targeted group is in any way linked by a common medical problem as such people generally are even less likely to divulge such information online. In addition it is not easily possible to verify if a given user indeed suffers from a given condition unless they can provide proof, which some people might be reluctant to do or is problematic under data protection considerations. In effect in some countries such practices are prohibited when relating to healthcare issues. In addition a link between a condition of a specific patient and any type of medical advice would in many countries be considered as a medical diagnostic tool, and would likely necessitate the regulatory approval for the packaging and its virtual content.

### SUMMARY

The present inventors have now discovered that simply the knowledge that a person accesses a certain product implies that he belongs to a given community of people, such as people suffering from a medical condition linked to this product. Therefore this product can be used as identifier for a person for example suffering from a medical condition such as a chronic or long-term illness and can act as a code or ticket for entry into specific online communities that cannot be accessed by a user in any other way. This is especially true when the product can only be obtained via some form of certification or prescription, like medical products related to a given disease or disorder.

This has the advantage to provide access control and privacy to people wanting to join forums exclusively for specific target communities such as self help forums for people suffering from chronic or long-term illnesses and other medical conditions. Furthermore unless the user wants and specifically agrees to it there is no identification of a specific user and therefore no issues in respect to the divulgence of personal and sensitive data or the classification of the packaging and the virtual content as diagnostics.

According to one aspect of the invention there is provided a method for providing an online communication platform for a targeted community of people, comprising the steps of:

a.) choosing a community of people

b.) identifying a product accessed by the community of people, the product comprising one or more product units;

c.) providing a product identifier on the product units;

d.) providing an online communication platform, wherein the communications platform is accessed by reading the identifier using a suitable device or entering the product identifier manually into a suitable piece of software; and wherein the product identifier is the only way for a user to access the online communication platform.

While the individual steps in the method of the invention are displayed in a certain order and labelled a.) to d.) this is merely meant to identify individual steps and there is no need to perform the steps in the order given. In the method of the invention the various steps can be performed in a different order without departing from the spirit of the invention.

In another aspect of the invention there is provided a system for selectively providing information to a targeted community of people, the system comprising,
at least one product, said being provided with at least one product identifier, and
an online communication platform, wherein the product identifier is the only way for a user to access the online communication platform.

For the purpose of the present invention the expression “the only way for a user to access the online communication platform” means that a user must use the product identifier at least once to gain initial access to the communication platform. After the initial access it is possible to give the user other means of access such as the option of creating a username and a password for further access or to install or activate a specific software such as one or more applications on a device used by the user that can be used to access the online communication platform. In some cases it may be preferable if the user creates other means of access once he has initially scanned the product. In other cases it may be preferable if the user has to scan the product every time he wants to access the communication platform.

In some aspects of the invention the online communication platform is selected from the group consisting of message boards, chat rooms and life online audio or video communication.

In addition to the communication platform it is possible to provide the user with further services tailored to his particular situation and in particular medical condition. It is for example possible to give the user the chance to identify his position using location services and identify other members of the community nearby and if desired and enable contact them for a face to face meeting. It is also possible to use the location information to provide indications of nearby institutions and businesses that cater to the needs of the specific community, such as for example diabetic friendly restaurants, pharmacies, doctors or fitness facilities.

Another potentially interesting service would be the provision of coaching tools to help a community member deal with his condition or to help ameliorate or improve the condition, for example through better compliance or lifestyle changes such as eating habits or exercise.

It is also possible to use the code to provide additional information to the users such as for example the expiry date of a product, security information to ensure that the product is genuine and not counterfeit, information on the proper use of the product or warnings in case of a product recall.

Other services might revolve around the provision of special services tailored to members of such a community, such as for example food or restaurant guides for diabetes patients. Such services might be particularly interesting as they could include recommendations or reviews by other members of the community or consist exclusively of such peer-reviews.

In its simplest form the product identifier can be attached by printing a web-address and/or an access code on the product. In some aspects though it might be advantageous if the process of logging onto the communication platform is automated. The latter can be achieved by providing the product with machine readable identifiers or coding tags. These identifiers or tags can be read by a user using a suitable device, whereby the device can then automatically or when prompted by the user launch the correct software to connect to the online communication platform.

Several types of data communication technologies can be used to attach the product identifier to a product. Examples for such technologies include for example coding tags such as barcodes, QR codes, Zapcodes, Datamatrix codes and NFC or RFID tags. Such tags require a digital reader—either optical or radio—so that their content can be read and interpreted. In some embodiments the tag might be incorporated into the product or packaging or might be the product or packaging or at least part of the product or packaging itself In this case the tag can be read using image recognition software. These tags require an active intervention by the person willing to have access to the information contained in the tag, via some specific reader. Their inclusion in the product (or its packaging) though does not require any extra source of energy, which makes them highly miniaturizable, and usually low cost.

Other examples for useful tags include miniaturized active wireless devices that can secure autonomous communication with any pre-existing wireless network. These technologies require little to no intervention from the person holding the product (or its packaging) but require a source of energy (e.g. a battery) which makes them less miniaturizable, and usually considerably more expensive than “passive” technologies. Examples for such active tags include devices utilizing SIM cards, Bluetooth, Zigbee or WiFi connectivity.

Devices using SIM cards have the advantage of full autonomy to communicate as soon as a mobile phone network is available. This is the basis for the Internet of Things (IoT) in which objects can communicate between themselves via Machine-to-Machine (M2M) protocols Bluetooth, Zigbee or WiFi based devices have short range communication capabilities and must access a hub to relay the information onto the internet. The hub in turn can be a mobile phone.

In due to their size, cost and simplicity in some cases coding tags can be preferred. In some aspects of the invention the product identifier is provided in the form of at least one tag selected from the group consisting of barcodes, QR codes, Datamatrix codes, Zapcodes, RED tags and NFC tags.

In some aspects of the invention the product identifier is incorporated into the packaging or product or is formed by at least a part of the packaging or product.

The product identifier will be attached to or part of the product itself or at least one part of its packaging, such as the primary packaging (e.g. a container for a liquid product or a product in powder form), the secondary packaging (e.g. a box for the primary packaging) or the tertiary or higher order packaging (boxes in which several units of product are combined, for example for distribution). In general the product identifier will be attached to at least one of the primary packaging and the secondary packaging.

The expression suitable device relates to any device that can read the product identifier, communicate the product identifier to a suitable piece of software and using the suitable piece of software, connect to the online communication platform. Examples of electronic devices that can read tags such as barcodes, QR codes, Datamatrix codes or any other type of tags or images that can serve as trackers, i.e. can be interpreted as digital information are generally known. Preferably these devices are based around technology that is already available at the end user. Examples of devices that can be used include both stationary and mobile computers with a suitable reader such as a scanner or a camera or mobile telephones or tablets, again with a suitable reader such as a camera or scanner.

The suitable device further communicates the product identifier to a suitable piece of software and using the suitable piece of software connects to the online communication platform. The access to the online communication platform can take place by any means known to a person skilled in the art and will most likely take place using a data connection such as a wired WAN or LAN connection, a WiFi connection or a mobile telephony or data connection. It is nevertheless possible to use other means of access such as landline telephone connections, other wireless connections such as Bluetooth.

In some aspects of the invention the suitable device is selected from the group consisting of camera equipped computers, scanner equipped computers, camera equipped PDAs, scanner equipped PDAs, camera equipped mobile telephones and scanner equipped mobile telephones. In some aspects of the invention the suitable device is a smartphone, in particular a smartphone with a camera. Such a smartphone will have the capability to connect to the internet.

In some aspects of the invention the suitable piece of software is an application or a suite of applications running on a smartphone. In some aspects of the invention the suitable device is a camera connected to a computer.

The expression suitable piece of software refers to any piece of software that is capable of connecting to the online communication platform. In its simplest form the suitable piece of software can be a web-browser, whereby the product identifier contains, links or refers to a web-address that can be accessed via the web-browser.

In this case it may be useful if the product identifier further comprises a further identifier in order to avoid the possibility of access to the web-site by simply entering a web-address for example obtained by a third party. It is also possible though that the suitable piece of software is a proprietary piece of software or a third party piece of software that might have been specifically modified for use in the methods and systems of the invention.

In some aspects of the invention the product identifier comprises a unique unit identifier which is tied to the specific product unit the user is using. In other aspects of the invention the unique unit identifier will only permit a singular access to the online communication platform. In some aspects of the invention the product identifier or the unique unit identifier will only permit access to the online communication platform in a specific time window.

These measures may increase the security against intrusion into the communication platform by unauthorized users.

One of the important points for the method/system of the invention is that the product identifier does not identify an individual user but merely that the user belongs to a specific group of people. While it is possible to further give the user the option to register more specific details for example to take part in loyalty schemes or to obtain a more personalized service this is merely an option and not mandatory for the invention. Since there is no need to register the individual readers within the system the privacy of the individual user remains protected if he so wishes as neither the user nor the number of users are registered in the system unless the user actively does so. Although in most cases each group will contain at least two persons a user's identity is protected even if the group only contains only one member as no user identification needs to be transmitted and the number of users per group is not registered. Even in case the system uses unique unit identifiers the system will not even be able to tell if two product units were accessed by the same user or two different users unless the user explicitly agrees to share this information.

In some aspects of the invention the product is selected from the group consisting of medical devices, drug products, personal care products, nutritional supplements, nutraceuticals, functional foods and foodstuffs, preferably drug products and in particular prescription drug products.

In some aspects of the invention the targeted community consists of people suffering from a disease or disorder. Such a disease or disorder can for example be a chronic or long-term disease or disorder or a non-chronic disease or disorder.

Due to the method/system of the invention it can be ensured that the online communication platform is available to only the selected target community therefore giving people the opportunity to communicate about common issues without the need for individuals to specifically identify themselves as being members of this community.

### DETAILED DESCRIPTION

In one embodiment of the invention the product is an insulin cartridge for an insulin pen. The insulin cartridge is thereby provided with a unique product identifier, in the instant case in the form of a QR code. Alternatively or additionally the unique product identifier can be provided in the form of a Datamatrix code When the user, i.e. diabetes patient is about to use the cartridge he can scan the QR code using his smartphone. Once the QR code is scanned an application installed on the smartphone is launched. This application takes the form of a dashboard from which it is possible to connect to an online chat room. This online chat room is thereby only accessible via the QR code on the cartridge.

In the online chat room the user can communicate directly with other diabetes patients, which most likely will be in the process of injecting themselves with insulin. He can use this connection for example to exchange experiences, gain or give support or trade tips on how to best inject oneself for example to minimize pain and discomfort.

In this particular chat room there is further the option of life audio or video streaming for example to demonstrate the best use of the insulin pen.

In addition to contact with other patients the user can opt to receive further information from medical professionals with respect to the best use of his insulin pen or lifestyle changes that might help ameliorate his condition.

The dashboard can further be used to access further functions or to launch other applications on the smartphone linked to the condition of the patient, in this case diabetes.

One such function or application can be used to provide newly diagnosed diabetes patients with additional support in coming to terms and getting used to living with their new condition in order to mitigate the stress experienced by newly diagnosed patients.

Another function or application can be used to ensure that the insulin is genuine and not counterfeit, to check if it is the correct type or to receive a warning in case the particular product unit is under recall. Another function or application can be used to provide information on food, such as pre-prepared meals or ingredients available in a shop or meals in a restaurant. This information is preferably crowd-sourced from other identified members of the community to ensure the reliability of the information.

Another function of application can take the form of a coaching tool that can advise on lifestyle changes in order to improve the general well-being of the patient. Furthermore the user can input data about his food consumption, insulin use, blood glucose and/or exercise regimen into the application to further individualize the advice given. The input of the data can thereby be either manual or via an automatic transfer from a suitable device such as a Wi-Fi-enabled blood glucose monitor or a fitness tracker. It might even be possible to use such an application to help a patient to adjust his insulin use to changes in his regular life style for example when travelling in different time zones or when business or leisure activities disrupt the usual eating habits or injections routines.

Another function or application might give the user the opportunity to use locations services to make his location know to other community members and to find other community members nearby. This information can then be used to arrange a face-to-face meeting. It is even possible to envisage that a user indicates that he is willing and able to supply insulin to other community members in case of an emergency such as the loss of the personal insulin supply while away from home or the discovery that the insulin currently carried is under recall and shouldn't be used. It is also possible to use the location information to provide indications of nearby institutions and businesses that cater to the needs of the specific community, such as for example diabetic friendly restaurants, pharmacies, doctors or fitness facilities.

In any case the user can be sure that unless he himself decides to register for any service that his identity is protected all the time while accessing the chat room. Furthermore the patient can also be certain that all other people present in the chat room will be diabetes patients as well therefore significantly reducing issues related to bullying and abuse of certain groups of people.

In another embodiment of the invention the product is an epinephrine autoinjector. The autoinjector is thereby provided with a unique product identifier, in the instant case in the form of a Datamatrix code. When the user, i.e. a person suffering from severe allergic reactions obtains the autoinjector he can scan the Datamatrix code using his smartphone. Once the Datamatrix code is scanned he is taken to a web-site and given the option to install and/or activate a special smartphone application. This application takes the form of a dashboard from which it is possible to connect to an online chat room. This online chat room is thereby only accessible via the application that is activated through the Datamatrix code on the autoinjector.

In the online chat room the user can communicate directly with other patients suffering from problems with severe allergic reactions. He can use this connection for example to exchange experiences, gain or give support or trade tips on how to best deal with the problems associated with severe and often life threatening allergic reactions.

Furthermore the application can provide other functions to the user.

Another function or application might give the user the opportunity to enter the things such as for example foodstuffs the he is allergic to. He can then use the function or application to scan barcodes provided on products, such as foodstuffs, to see if they are known to contain or be free of the allergens in question. It might be possible that such information, at least in parts, is crowdsourced from other users of the application who have come into contact with the products in question. This function could also be used to provide the user with information on nearby restaurants and the suitability of their menu for his allergies.

Another function or application can be used to ensure that the autoinjector is genuine and not counterfeit or to receive a warning in case the particular product unit is under recall.

Another function or application can be used to provide emergency assistance. It is for example possible that the user can activate a distress signal using the application. It is also possible that the app can provide information on how to respond to the allergic reaction to bystanders or first-aiders aiding the user in case of an allergic reaction. In some embodiments it might be conceivable that the autoinjector is able to directly communicate with a smartphone, for example using Bluetooth, and activate an alarm or trigger an alarm mode, to for example provide information, of the application automatically upon activation.

In a further embodiment the product is an antiretroviral drug for HIV/AIDS sufferers. In this case the product identifier is a combination of a code and a web-address. In order to access the online communication platform the user launches a web-browser, be it on a desktop or notebook computer or on a smartphone or tablet and enters the web-address. When the browser connects the to the web-address the user is prompted to enter the code from packaging of the drug and upon successful entry is admitted to the online communication platform. In this case the packaging comprises a number of codes corresponding to the number of individual doses in the package and each code can only be used once.

In this case the online communication platform is a message board where patients can read and join discussions and read or leaves messages from or for other patients. Discussions can hereby be directed to specific issues such as for example how to deal with given side effects of the drug or more general and relating to lifestyle issues of HIV/AIDS sufferers.

Again the patient can feel safe in the knowledge that his identity is protected and that all other members of the message board are HIV/AIDS sufferers, thereby reducing bullying and giving the information received a higher degree of authenticity.

1. A method for providing an online communication platform for a targeted community of people, comprising the steps of:
choosing a community of people
identifying a product accessed by said community of people, said product comprising one or more product units;
providing a product identifier on said product units; and
providing an online communication platform, wherein said online communication platform is accessed by reading said product identifier using a suitable device or entering said product identifier manually into a suitable piece of software; and
wherein the product identifier is the only way for a user to access the online communication platform.

2. The method of claim 1 wherein said online communication platform is selected from the group consisting of message boards, chat rooms and life online audio or video communication.

3. The method of claim 1 wherein said product identifier is provided in the form of at least one tag selected from the group consisting of barcodes, QR codes, Datamatrix codes, Zapcodes, RFID tags and NFC tags.

4. The method of claim 1 wherein said product identifier is incorporated into the packaging or product or is formed by at least a part of the packaging or product.

5. The method of claim 1 wherein said suitable device is selected from the group consisting of camera equipped computers, scanner equipped computers, camera equipped PDAs, scanner equipped PDAs, camera equipped mobile telephones and scanner equipped mobile telephones.

6. The method of claim 5, wherein said mobile telephone is a smartphone.

7. The system of claim 6 wherein said request suitable piece of software is an application or a suite of applications on said smartphone.

8. The method of claim 1, wherein said product is selected from the group consisting of medical devices, drug products, personal care products, nutritional supplements, nutraceuticals, functional foods and foodstuffs and preferably is a drug product, in particular a prescription drug product.

9. The method of claim 1, wherein the targeted community consists of people suffering from a disease or disorder, in particular a chronic or long-term disease or disorder.

10. The method of claim 1, wherein the product identifier comprises a unique unit identifier.

11. The method of claim 10, wherein the unique unit identifier will only permit a singular access to the online communication platform.

12. The method of claim 10, wherein the unique unit identifier will only permit access to the online communication platform in a specific time window.

13. A system for selectively providing information to a targeted community of people, the system comprising,
at least one product, said being provided with at least one product identifier, and
an online communication platform,
wherein the product identifier is the only way for a user to access the online communication platform.

14. The system of claim 13 wherein said online communication platform is selected from the group consisting of message boards, chat rooms and life online audio or video communication.

15. The system of claim 13 wherein said unique identifier is provided in the form of at least one tag selected from the group consisting of barcodes, QR codes, Datamatrix codes, Zapcodes, RFID tags and NFC tags.

16. The system of claim 13 wherein said product identifier is incorporated into the packaging or product or is formed by at least a part of the packaging or product.
